(19) United States
(12) Patent Application Publication
(10) Pub. No.: US 2025/0002294 A1
(43) Pub. Date: Jan. 2, 2025

(54) ROBOT USE OF DESTINATION DISPATCH ELEVATORS

(71) Applicant: Johnson Controls Tyco IP Holdings LLP, Milwaukee, WI (US)

(72) Inventors: Jason M. OUELLETTE, Leominster, MA (US); Lepphei ADAM, Milwaukee, WI (US); Glenn Kilburn HOLTON, Braintree, MA (US); Brian C. RICHARD, Lunenburg, MA (US); Sanela SULJIC, Nashua, NH (US); Saravanabavanandam SADAKSHARAM, Milwaukee, WI (US)

(21) Appl. No.: 18/343,686

(22) Filed: Jun. 28, 2023

(51) Int. Cl. B66B 1/34; B66B 1/46; B66B 3/00; G05D 1/02

(52) U.S. Cl. CPC B66B 1/3461; B66B 1/468; B66B 3/002; B66B 2201/101; B66B 2201/103; B66B 2201/405; B66B 2201/4615; B66B 2201/4638; B66B 2201/4653; B66B 2201/4676

(57) ABSTRACT

Disclosed herein are apparatuses and methods for controlling a robot to use an elevator of a building. A tag indicating arrival at an elevator block can be received from a robot. Based on receiving the tag, a credential for the robot can be transmitted to an elevator system. An indication of an elevator cab assigned to the robot can be received from the elevator system. A command to travel to the elevator cab can be transmitted to the robot.

### TECHNICAL FIELD

The described aspects relate to controlling movement of robots within a building.

### BACKGROUND

Aspects of the present disclosure relate generally to controlling movement of robots within a building, and more particularly, to enabling robots to use destination dispatch elevators to move within a building.

Buildings are starting to employ destination dispatch (DD) elevator systems. A DD system includes a bank of one or more elevator cabs and a kiosk that receives a physical user credential from a person desiring to use an elevator cab. Based on the credential, the DD elevator system can determine a home floor and/or a set of additional floors of the building that the person can access. The kiosk can display, to the person, a set of floors from which the person can select. The DD elevator system can handle various floor requests and can allocate elevator cabs to persons to achieve efficiency in operating the elevator cabs. For example, the DD elevator system can group persons going to similar sets of floors in a same elevator cab. The DD elevator system can announce, to the person, the elevator cab allocated for the person. In this regard, DD elevator systems can provide power savings by allocating persons going to a same or nearby floor in a same elevator cab and/or can provide building security by limiting floors to which a person can travel.

Security management systems in buildings can utilize robots for various purposes related to building security. For example, robots can patrol a floor of a building and can use various sensor devices to observe safety device presence or status, observe potential obstructions in building ingresses or egresses, observe indicated possible incidents, investigate areas where alarms are triggered, etc. Robots are typically deployed on a single floor of a building for which robot patrol is desired.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

An example implementation includes a computer-implemented method for controlling a robot to use an elevator of a building. The method includes receiving, from the robot, a tag indicating arrival at an elevator block, transmitting, to an elevator system and based on receiving the tag, a credential for the robot, receiving, from the elevator system, an indication of an elevator cab assigned to the robot, and transmitting, to the robot, a command to travel to the elevator cab.

Another example implementation includes an apparatus for controlling a robot to use an elevator of a building. The apparatus includes one or more memories configured to, individually or in combination, store instructions, and one or more processors communicatively coupled with the one or more memories. The one or more processors are, individually or in combination, configured to execute the instructions to cause the apparatus to receive, from the robot, a tag indicating arrival at an elevator block, transmit, to an elevator system and based on receiving the tag, a credential for the robot, receive, from the elevator system, an indication of an elevator cab assigned to the robot, and transmit, to the robot, a command to travel to the elevator cab.

Another example implementation includes one or more computer-readable media storing instructions, executable by one or more processors, for controlling a robot to use an elevator of a building. The instructions include instructions for receiving, from the robot, a tag indicating arrival at an elevator block, transmitting, to an elevator system and based on receiving the tag, a credential for the robot, receiving, from the elevator system, an indication of an elevator cab assigned to the robot, and transmitting, to the robot, a command to travel to the elevator cab.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a diagram of an example of a building floor for inspection by a robot, in accordance with certain aspects of the present disclosure.

FIG. 2 is a block diagram of one or more computing device(s) for executing a security management system that can operate or provide information to a robot for patrolling one or more floors of a building, in accordance with certain aspects of the present disclosure.

FIGS. 3A and 3B illustrate a flowchart of an example of a method for enabling a robot to use an elevator system in a building, in accordance with certain aspects of the present disclosure.

FIG. 4 illustrates an example of a communication flow for enabling a robot to use an elevator system, in accordance with certain aspects of the present disclosure.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

Aspects described herein relate to enabling a robot to use a dedicated dispatch (DD) elevator system in a building. A security management system in the building can manage or control the robot to travel within the building, perform security-related operations, etc. For example, the security management system can employ a robot that can detect or notify on possible safety issues in one or more pathways of the building, observe safety equipment (e.g., fire extinguisher, smoke detector, etc.) status (e.g., charge level, battery status, etc.), observe obstructions in pathways of the building or to ingresses or egresses, investigate and report on areas having triggered alarms, etc. For example, the security management system can receive input from multiple sensors on the robot, and may detect the possible safety issues, safety equipment status, obstructions, investigate the triggered alarms, etc., based on the input. For example, the sensors can include one or more cameras (e.g., a depth camera, red, green, blue (RGB) camera, infrared camera, light detection and ranging (LiDAR) device, temperature sensor, smoke detector, microphone, etc.

In a specific example, the system can use a robot (e.g., which may be a vehicle, drone, etc.) that uses software integration with the security management system. The software integration can allow for the security management system to provide, to the robot, information about the building that the robot is to patrol (e.g., a floor map, location and placement of security and safety equipment such as readers, cameras, smoke detectors, fire extinguishers, hoses, sprinklers, etc.), and/or the like. The security management system can also command the robot on where/how to move within the building to collect desired patrol information. For example, the security management system can provide the robot with a set of tag types, and the robot can report, to the security management system, when it encounters a tag, and the security management system can command the robot to operate in a certain way based on the tag (e.g., to capture data using one or more sensors, to travel to a next tag, etc.). Using this information, e.g., along with a library of trained artificial intelligence (AI), the robot can conduct scheduled or manually requested tours of the building to inspect muster paths and security equipment. The robot using the software integration can report, to the security management system in real time using network protocols, any obstructions, chained or barricaded doors, faulty security/safety equipment such as a discharged fire extinguisher or offline reader, other safety issues, detected incidents, etc., or associated information (e.g., sensor readings, images, etc.), to facilitate detecting the obstructions or issues or incidents using AI.

Aspects described herein provide functionality for a robot to use an elevator system (e.g., a DD elevator system), such as for patrolling multiple floors of a building. For example, the robot can report arrival at a kiosk of an elevator system where the kiosk can relate to multiple elevator cabs in an elevator bank. Based on the reported arrival of the robot, the security management system can transmit a virtual credential of the robot to the elevator system. The security management system can receive, from the elevator system, an indication of an elevator cab in the elevator bank that is allocated to the robot. In one example, the robot can travel to a certain floor via the elevator cab, where the floor can be requested by the security management system, and/or the elevator system can verify that the robot can access the requested floor. Based on receiving the indication of the elevator cab, the security management system can instruct the robot to travel to the elevator cab and/or attempt to detect an exterior door opening at the elevator cab. For example, the robot can use images captured via a camera on the robot to detect the exterior door opening, or can provide the images to the security management system for detecting the exterior door opening, via AI. Based on detecting the exterior door opening, the robot can (or can be commanded by the security management system to) enter the elevator cab. The robot can be similar configured to detect, or provide images for detecting, opening of an interior door of the elevator cab, and exiting the elevator cab when the interior door is open.

In this regard, aspects described herein can enable robots to travel to different floors of a building using an elevator system, such as a DD elevator system. This can effectively eliminate a requirement that each floor for which patrol is desired have its own robot. This can reduce the number of robots, which can reduce associated cost, complexity, and space used by operating multiple robots. In addition, the robots are not required to have arms or actuators to engage elevator buttons where the DD elevator system is used.

As used herein, a processor, at least one processor, and/or one or more processors, individually or in combination, configured to perform or operable for performing a plurality of actions is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

As used herein, a memory, at least one memory, and/or one or more memories, individually or in combination, configured to store or having stored thereon instructions executable by one or more processors for performing a plurality of actions is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, and second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, in combination, execute the respective subset of instructions to accomplish performing actions X, Y, and Z. Alternatively, three processors may access one of three different memories each storing one of instructions for performing X, Y, or Z, and the three processor may in combination execute the respective subset of instruction to accomplish performing actions X, Y, and Z. Alternatively, a single processor may execute the instructions stored on a single memory, or distributed across multiple memories, to accomplish performing actions X, Y, and Z.

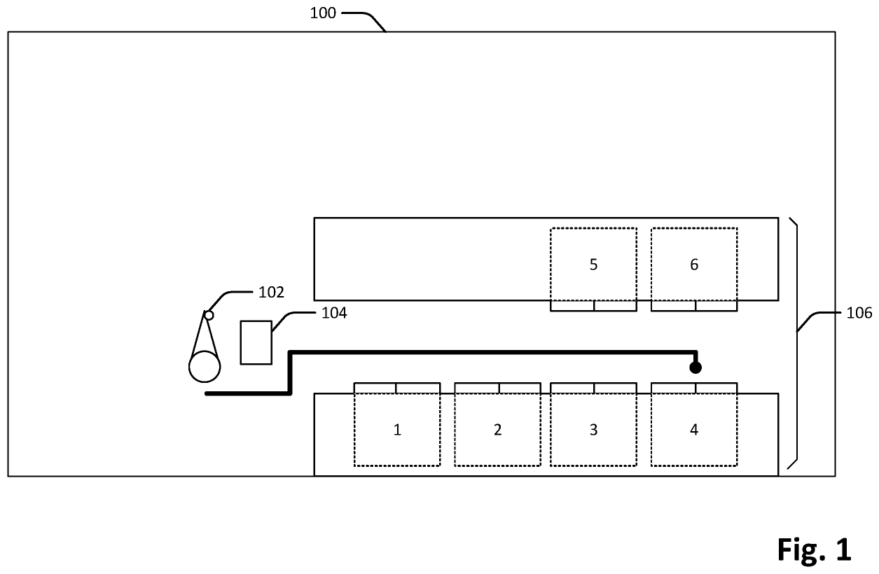

FIG. 1 is a diagram of an example of a building floor 100 for inspection by a robot 102. The building floor 100 can include at least one kiosk 104 for using an elevator bank 106. The elevator bank 106 can include multiple elevator cabs 1, 2, 3, 4, 5, 6. The robot 102 can patrol the building floor 100, and can arrive at the kiosk 104 to travel to another building floor via an elevator cab. For example, robot 102 can report arrival at the kiosk 104, based on which a security management system (not shown) can provide a virtual credential of the robot to an associated elevator system (not shown), receive an indication of the elevator cab for the robot 102, and command the robot 102 to travel to the elevator cab, which can be elevator cab 4 in the depicted example. The robot 102 can travel to elevator cab 4 and wait for the exterior door of the elevator cab 4 to open, after which robot 102 can enter the elevator cab 4.

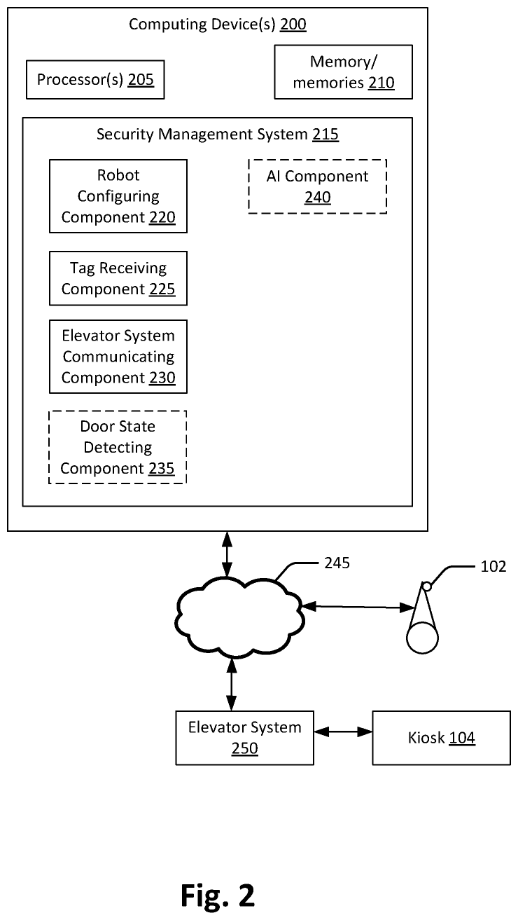

FIG. 2 is a block diagram of one or more computing device(s) 200 for executing a security management system 215 that can operate or provide information to a robot 102 for patrolling one or more floors of a building. Computing device(s) 200 can include one or more processors 205 and/or one a memory/memories 210 configured to execute or store instructions or other parameters related to performing one or more processes, executing the security management system 215, etc. For example, processor(s) 205 and memory/memories 210 may be separate components communicatively coupled by a bus (e.g., on a motherboard or other portion of a computing device, on an integrated circuit, such as a system on a chip (SoC), etc.), components integrated within one another (e.g., processor(s) 205 can include the memory/memories 210 as an on-board component), and/or the like. Memory/memories 210 may store instructions, parameters, data structures, etc. for use/execution by processor(s) 205 to perform functions described herein.

In an example, the security management system 215 can include a robot configuring component 220 for configuring a robot 102 to patrol one or more floors of a building for obtaining information regarding devices in the building, which may include safety equipment devices, doors, windows, or other points of egress or ingress, information regarding obstructions in the building, information regarding possible safety issues in the building, information for investigating triggered alarms, etc. In another example, security management system 215 can include a tag receiving component 225 for receiving, from the robot 102, one or more tags indicating arrival of the robot 102 at a location, or an elevator system communicating component 230 for communicating with an elevator system in the building (e.g., a DD elevator system). In another example, security management system 215 can optionally include a door state detecting component 235 for detecting an elevator cab door opening (e.g., an exterior or interior door of an elevator cab), and/or an AI component 240 for detecting door state or other information using AI (e.g., comparing captured images or other sensor readings to images or readings indicating the door state or other information). In an example, AI component 240 can use a neural network of images or other inputs to compare captured images or other inputs to detect certain status information. In one example, AI component 240 can use a generative adversarial network (GAN), which can include a machine learning model in which two neural networks (a generator and a discriminator) that compete with each other by using deep learning methods to become more accurate in their predictions. In other examples, AI component 240 can bypass the GAN (e.g., for a different neural network used), or can bypass one of the generator or discriminator (e.g., assuming they are well trained) in detecting the status information based on provided inputs.

For example, computing device(s) 200 can communicate with one or more other devices or systems via a network 245. For example, computing device(s) 200 can communicate with the robot 102 to configure the robot 102 for touring the building and/or providing safety device, obstruction, incident, etc. information observed in the building. In another example, computing device(s) 200 can communicate with an elevator system 250 to request elevator operation for the robot 102 to travel to different floors of the building. As described, for example, elevator system 250 can include a kiosk 104 to which the robot 102 can travel and report arrival at the kiosk 104 to initiate elevator operation for the robot 102.

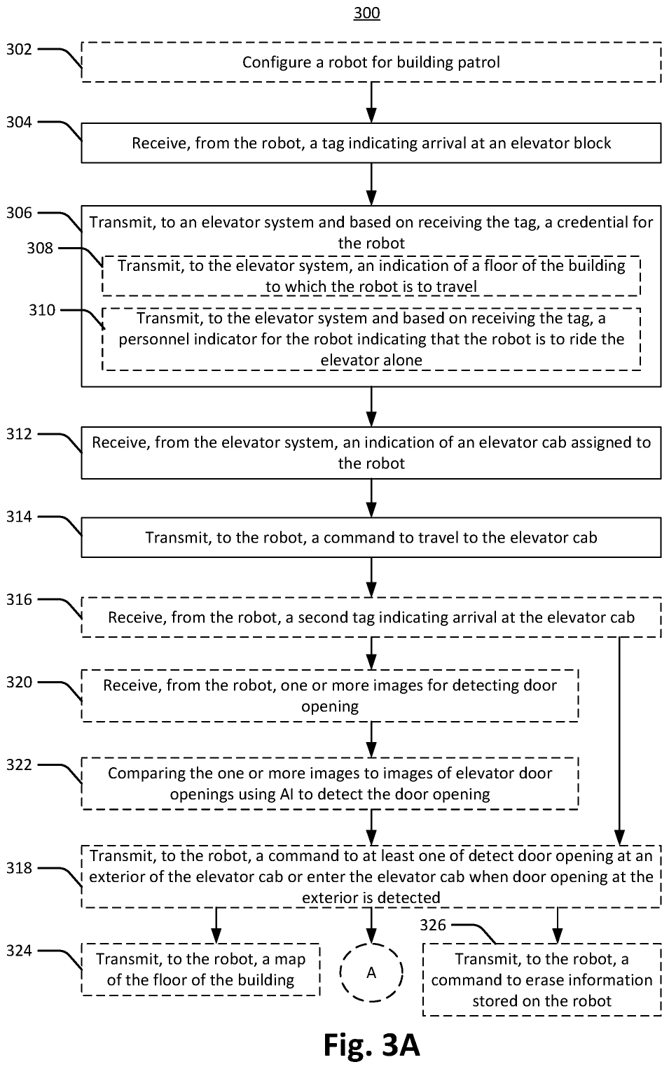

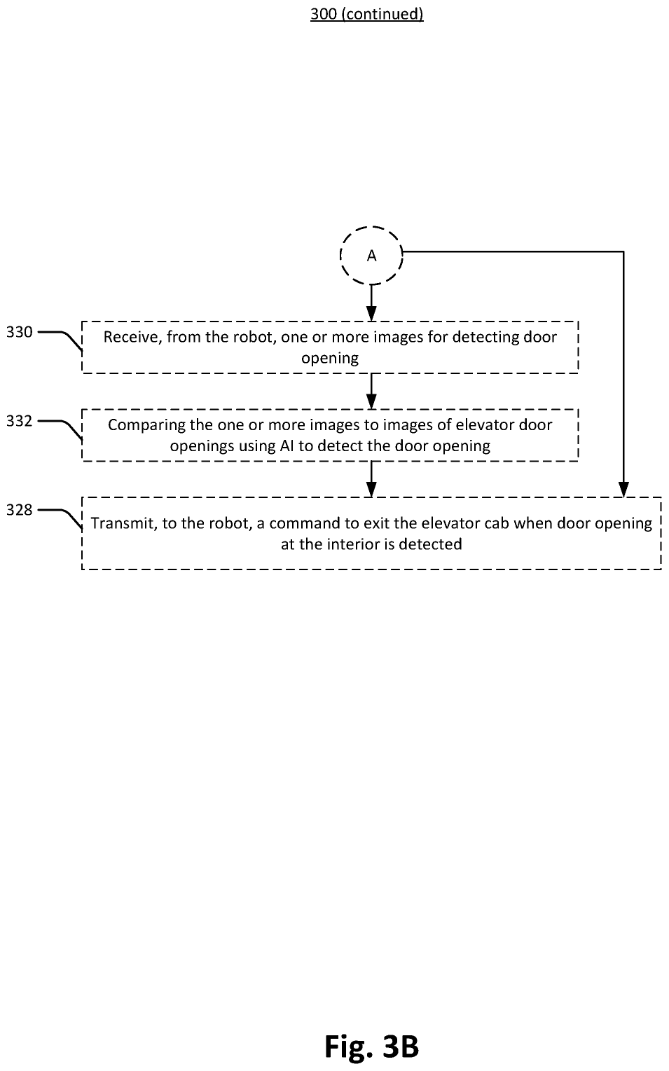

FIGS. 3A and 3B illustrate a flowchart of an example of a method 300 for enabling a robot to use an elevator system in a building. For example, method 300 can be performed by a computing device(s) 200 and/or one or more systems or components thereof to facilitate elevator operation for a robot.

At block 302, method 300 can optionally include configuring a robot for building patrol. In an aspect, robot configuring component 220, e.g., in conjunction with computing device(s) 200, processor(s) 205, memory/memories 210, security management system 215, etc., can configure the robot (e.g., robot 102) for building patrol. For example, this can include robot configuring component 220 configuring robot 102 with a schedule for performing building patrol, configuring robot 102 with a specific request for patrolling the building or investigating a certain device, obstruction, incident, etc., configuring robot 102 with a map of one or more floors to patrol, and/or the like.

In an example, robot configuring component 220 can configure the robot 102 to periodically inspect the one or more devices or areas based on specifying properties of the one or more devices or areas to be inspected. In an example, the robot 102 may include multiple sensor devices for detecting the status of one or more devices, such as a camera for visual inspection, LiDAR device, etc. For example, robot configuring component 220 can configure the robot 102 to inspect pathways, safety devices, ingresses/egresses, triggered alarms, etc. In other examples, robot configuring component 220 can configure the robot 102 to inspect various devices, such as smoke detectors (e.g., a light emitting diode (LED) or RFID-read status on the smoke detector), hoses, sprinklers, security cameras (e.g., to ensure the cameras are on-line via LED indicator, in-focus, etc.) and/or the like. In other examples, robot configuring component 220 can configure the robot 102 to take pictures at certain locations, and AI component 240 can determine the relevant status information of the devices based on comparing the images to images of known status information using AI. The robot configuring component 220 can also configure the robot 102 to report other information related to the status information, such as a location or identifier of the device that can allow the security management system 215 to determine a location of a possible safety issue.

At block 304, method 300 can include receiving, from the robot, a tag indicating arrival at an elevator block. In an aspect, tag receiving component 225, e.g., in conjunction with computing device(s) 200, processor(s) 205, memory/memories 210, security management system 215, etc., can receive, from the robot (e.g., robot 102), the tag indicating arrival at the elevator block. For example, the robot 102 can transmit the tag to the security management system 215 based on detecting the tag (e.g., reading a radio frequency identification (RFID) tag), based on detecting the robot 102 is in a location (e.g., a global positioning system (GPS) location) associated with the tag, etc. In one example, the tag can more specifically correspond to a kiosk of a DD elevator system associated with the elevator bank. In any case, the received tag can indicate presence of the robot 102 at the elevator bank.

At block 306, method 300 can include transmitting, to an elevator system and based on receiving the tag, a credential for the robot. In an aspect, elevator system communicating component 230, e.g., in conjunction with computing device(s) 200, processor(s) 205, memory/memories 210, security management system 215, etc., can transmit, to the elevator system (e.g., elevator system 250) and based on receiving the tag, the credential for the robot. In this regard, for example, the security management system 215 can present, to the elevator system 250, a virtual credential of the robot, which can include an n-bit value, in some examples, where n is a positive integer. The credential can be stored in the elevator system 250, similarly to values of physical credentials, and can be associated with one or more floors that the robot 102 can access. For example, the one or more floors can include a home or default floor and/or one or more other floors in the building.

In some examples, the elevator system 250 can allow or request floor selection for a person using the kiosk, where floors can be presented based on the person's credential. Thus, in an example, block 306 can optionally include, at block 308, transmitting, to the elevator system, an indication of a floor of the building to which the robot is to travel. In an aspect, elevator system communicating component 230, e.g., in conjunction with computing device(s) 200, processor(s) 205, memory/memories 210, security management system 215, etc., can transmit, to the elevator system (e.g., elevator system 250), the indication of the floor of the building to which the robot is to travel. The indication of the floor can be based on a patrol configured for the robot 102, for example. In addition, for example, elevator system communicating component 230 can transmit the indication of the floor when transmitting the credential. In another example, elevator system communicating component 230 can receive, from the elevator system 250, a response to transmitting the credential, where the response can indicate one or more floors to which the robot 102 is allowed to travel, and can transmit the indication of the floor in response to response from the elevator system 250. In any case, the indication of the floor can be based on a definition of the patrol for the robot 102, a manual request by an operator of the security management system 215, etc.

In an example, it can be desirable for the robot 102 to ride in an elevator cab alone (without other persons) for various reasons, such as to prevent tampering with the robot, to prevent discomfort in persons riding with a robot, etc. Thus, in an example, block 306 can optionally include, at block 310, transmitting, to the elevator system (e.g., elevator system 250) and based on receiving the tag, a personnel indicator for the robot indicating that the robot is to ride the elevator alone. In an aspect, elevator system communicating component 230, e.g., in conjunction with computing device(s) 200, processor(s) 205, memory/memories 210, security management system 215, etc., can transmit, to the elevator system and based on receiving the tag, the personnel indicator for the robot indicating that the robot is to ride the elevator alone. For example, the personnel indicator can be an indicator supported by the elevator system 250 for such a purpose (e.g., a very important person (VIP) indicator or service personnel indicator), where the indicator can typically be tied to a credential such that when the credential is presented, the elevator system 250 can allocate elevator cabs considering the VIP or service personnel should be allocated their own elevator cab.

At block 312, method 300 can include receiving, from the elevator system, an indication of an elevator cab assigned to the robot. In an aspect, elevator system communicating component 230, e.g., in conjunction with computing device(s) 200, processor(s) 205, memory/memories 210, security management system 215, etc., can receive, from the elevator system (e.g., elevator system 250), the indication of the elevator cab assigned to the robot. As described, the elevator system 250 can select the elevator cab for the robot as it would for other persons, such as by grouping persons (and/or the robot) traveling to the same or nearby floors in a same elevator cab, considering possible VIP or service personnel status, etc. The elevator system 250 can transmit an indication of the elevator cab selected for the robot 102 to the security management system 215, as an audible alert to the robot 102, which the robot 102 can receive via a microphone and process or provide to the security management system 215 for processing, etc.

At block 314, method 300 can include transmitting, to the robot, a command to travel to the elevator cab. In an aspect, robot configuring component 220, e.g., in conjunction with computing device(s) 200, processor(s) 205, memory/memories 210, security management system 215, etc., can transmit, to the robot (e.g., robot 102), the command to travel to the elevator cab that is selected by the elevator system 250 for the robot 102 and/or to await detection of the exterior door of the elevator cab opening. In any case, the robot 102 can travel to the assigned elevator cab and/or can begin a detection process for detecting when the exterior door of the elevator cab opens or is opening.

At block 316, method 300 can optionally include receiving, from the robot, a second tag indicating arrival at the elevator cab. In an aspect, tag receiving component 225, e.g., in conjunction with computing device(s) 200, processor(s) 205, memory/memories 210, security management system 215, etc., can receive, from the robot (e.g., robot 102), the second tag indicating arrival at the elevator cab. For example, tag receiving component 225 can receive the second tag based on commanding the robot to travel to the assigned elevator cab, and once the robot 102 reaches the assigned elevator cab, detects the tag at the elevator cab or the associated location, etc. Based on arriving at the elevator cab, robot 102 can begin a detection process to detect an exterior door of the elevator cab opening or being open, which can be based on a command from the security management system 215 based on arriving at the elevator cab or otherwise.

At block 318, method 300 can optionally include transmitting, to the robot, a command to at least one of detect door opening at an exterior of the elevator cab or enter the elevator cab when door opening at the exterior is detected. In an aspect, robot configuring component 220, e.g., in conjunction with computing device(s) 200, processor(s) 205, memory/memories 210, security management system 215, etc., can transmit, to the robot (e.g., robot 102), the command to at least one of detect door opening at the exterior of the elevator cab or enter the elevator cab when door opening at the exterior is detected. For example, robot configuring component 220 can configure the robot 102 to detect the door opening and/or enter the elevator cab based on receiving the second tag indicating arrival at the elevator cab. The robot 102 can be configured to capture images or other input of the exterior door of the elevator cab using LiDAR, an infrared camera, a RGB camera, etc. In one example, the robot 102 can be configured to detect the exterior door opening based on the images or other input. In another example, the robot 102 can be configured to provide images or other input to the security management system 215 to facilitate detecting the exterior door opening.

In this example, at block 320, method 300 can optionally include receiving, form the robot, one or more images for detecting door opening. In an aspect, robot configuring component 220, e.g., in conjunction with computing device(s) 200, processor(s) 205, memory/memories 210, security management system 215, etc., can receive, from the robot (e.g., robot 102), the one or more images for detecting door opening, which can be based on a command provided to the robot 102 to capture and provide the images. In addition, in this example, at block 322, method 300 can optionally include comparing the one or more images to images of elevator door openings using AI to detect the door opening. In an aspect, door state detecting component 235, e.g., in conjunction with computing device(s) 200, processor(s) 205, memory/memories 210, security management system 215, etc., can compare the one or more images to images of elevator door openings using AI to detect the door opening. For example, door state detecting component 235 can provide the one or more images as input to AI component 240 to use in comparing with images of elevator door openings to detect when the exterior door of the elevator cab is opening or is open. For example, this detection (e.g., using AI) can be performed by the security management system 215, as described, or at the robot 102.

In this regard, for example, the command transmitted to the robot at block 318 can include a command to detect the door opening using imaging and/or AI, as described above, or to provide images to the security management system 215 for detecting door opening. Based on detecting the door opening, the security management system 215 can command the robot 102 to enter the elevator cab. For example, this can be one command sent to the robot 102 to detect door opening and enter the elevator cab when door opening is detected. In another example, this can be multiple commands where the security management system 215 commands the robot 102 to enter the elevator cab once exterior door opening is detected (whether exterior door opening detection is performed by the robot 102 or by the security management system 215). In any case, robot configuring component 220 can transmit, to the robot 102, the command to enter the elevator cab. The robot 102 can accordingly enter the elevator cab.

In an example, robot configuring component 220 can transmit the command to enter the elevator cab including one or more parameters for entering the elevator cab. For example, the one or more parameters include a speed at which the robot is to enter the elevator cab, an orientation or position of the robot within the elevator cab, etc. For example, the orientation of the robot can correspond to whether a front door or a rear door of the elevator cab will open when the elevator cab reaches the destination floor. The robot 102 can accordingly enter the elevator cab at the indicated speed, can turn to face the indicated orientation in the elevator cab, etc.

In addition, in an example, the command to enter the elevator cab can also include parameters for occupancy detection to enable the robot 102 to detect, using one or more cameras to capture images, a number of occupants of the elevator cab before entering. In one example, robot 102 can send captured images to the security management system 215 to enable the security management system 215 to command the robot 102 to enter the elevator cab based on the number of occupants (e.g., where the number of occupants is detected to be at or below a threshold).

At block 324, method 300 can optionally include transmitting, to the robot, a map of the floor of the building. In an aspect, robot configuring component 220, e.g., in conjunction with computing device(s) 200, processor(s) 205, memory/memories 210, security management system 215, etc., can transmit, to the robot (e.g., robot 102), the map of the floor (e.g., the destination floor) of the building. This can allow the robot to effectively patrol the destination floor when it arrives at the destination floor.

At block 326, method 300 can optionally include transmitting, to the robot, a command to erase information stored on the robot. In an aspect, robot configuring component 220, e.g., in conjunction with computing device(s) 200, processor(s) 205, memory/memories 210, security management system 215, etc., can transmit, to the robot (e.g., robot 102), the command to erase information stored on the robot. For example, the command can relate to erasing certain confidential information that the robot may store to prevent hacking or other cyber-attack if the robot is removed from the facility during or as part of transport in the elevator cab. In one example, robot configuring component 220 can reconfigure the robot with the confidential information once it reaches the destination floor (e.g., based on receiving, from the robot 102, a tag associated with the destination floor).

In some examples, the robot 102 can also detect interior door opening once it is in the elevator cab to determine when to exit the elevator cab. At block 328, method 300 can optionally include transmitting, to the robot, the command to exit the elevator when door opening at the interior is detected. In an aspect, robot configuring component 220, e.g., in conjunction with computing device(s) 200, processor(s) 205, memory/memories 210, security management system 215, etc., can transmit, to the robot (e.g., robot 102), the command to exit the elevator cab when door opening at the interior is detected. In one example, this can be part of the command transmitted to the robot 102 at block 318, or can be a separate command once the robot 102 has entered the elevator cab (e.g., based on security management system 215 receiving a tag indicating the robot 102 is in the elevator cab).

In addition, for example, the robot 102 can be configured to detect the interior door opening using one or more images or other inputs captured by the robot 102, as described above, or can provide the one or more images or other inputs to the security management system 215 for detecting interior door opening. For example, at block 330, method 300 can optionally include receiving, form the robot, one or more images for detecting door opening. In an aspect, robot configuring component 220, e.g., in conjunction with computing device(s) 200, processor(s) 205, memory/memories 210, security management system 215, etc., can receive, from the robot (e.g., robot 102), the one or more images for detecting door opening, which can be based on a command provided to the robot 102 to capture and provide the images. In addition, in this example, at block 332, method 300 can optionally include comparing the one or more images to images of elevator door openings using AI to detect the door opening. In an aspect, door state detecting component 235, e.g., in conjunction with computing device(s) 200, processor(s) 205, memory/memories 210, security management system 215, etc., can compare the one or more images to images of elevator door openings using AI to detect the door opening from the interior of the elevator cab. For example, door state detecting component 235 can provide the one or more images as input to AI component 240 to use in comparing with images of elevator door openings to detect when the interior door of the elevator cab is opening or is open. For example, this detection (e.g., using AI) can be performed by the security management system 215, as described, or at the robot 102.

In this regard, for example, the command transmitted to the robot at block 328 can include a command to detect the door opening using imaging and/or AI, as described above, or to provide images to the security management system 215 for detecting door opening. Based on detecting the door opening, the security management system 215 can command the robot 102 to exit the elevator cab. For example, this can be one command sent to the robot 102 to detect door opening and exit the elevator cab when door opening is detected. In another example, this can be multiple commands where the security management system 215 commands the robot 102 to exit the elevator cab once interior door opening is detected (whether interior door opening detection is performed by the robot 102 or by the security management system 215). In any case, robot configuring component 220 can transmit, to the robot 102, the command to exit the elevator cab. The robot 102 can accordingly exit the elevator cab. The command to exit the elevator cab can include a speed at which the robot 102 is to exit the elevator cab and/or other parameters, as described. In one example, once the robot 102 exits the elevator, it can detect a tag associated with the destination floor and can send the tag to the security management system 215. In one example, the security management system 215 can transmit, to the robot 102, the floor map or other patrol information based on receiving this tag.

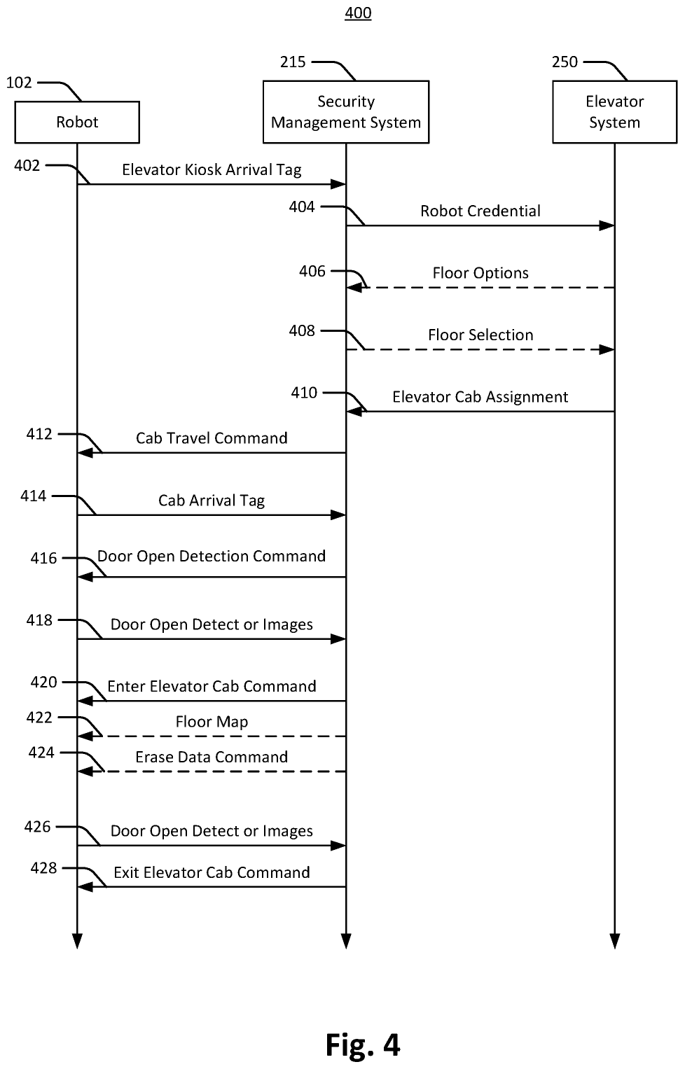

FIG. 4 illustrates an example of a communication flow 400 for enabling a robot to use an elevator system. Communication flow 400 can include communications between a robot 102, a security management system 215, and an elevator system 250. For example, robot 102 can transmit, to the security management system 215, an elevator kiosk arrival tag at 402 indicating that the robot 102 has arrived at an elevator kiosk. Security management system 215 can accordingly transmit a robot credential of the robot 102 to the elevator system 250 at 404, which can authenticate the robot 102 as a user of the elevator system and/or determine floors to which the robot 102 is allowed to travel based on the credential. Elevator system 250 can optionally transmit floor options for the robot 102 to the security management system 215, which can be based on the credential, at 406. Security management system can optionally provide a floor selection for the robot 102 to the elevator system 250 at 408. Elevator system 250 can provide an elevator cab assignment 410 for the robot 102 to security management system 215 assigning an elevator cab in the elevator bank.

Security management system 215 can transmit, to the robot 102, a cab travel command at 412 to travel to the assigned elevator cab. Robot 102 can travel to the assigned elevator cab and can transmit, to the security management system 215, a cab arrival tag at 414 when the robot 102 arrives at the elevator cab. Security management system 215 can transmit, to the robot 102, a door open detection command at 416. The robot 102 can attempt to detect door opening, or can provide images or other input to the security management system 215 to facilitate detecting door opening, as described. Robot 102 can provide an indication of detecting door opening, or can provide images or other inputs to facilitate detecting door opening, to the security management system 215 at 418. Once door opening is detected, security management system 215 can transmit, to the robot 102, a command to enter the elevator cab at 420, which can include one or more parameters for entering the elevator cab, such as a speed, an orientation the robot 102 is to face, etc. Based on detecting door opening or the robot 102 entering the elevator cab, security management system 215 may optionally also transmit a floor map to the robot at 422, a command to erase data at 424, etc., as described herein.

After the robot 102 enters the elevator cab, it can attempt to detect interior door opening. Robot 102 can also transmit, to the security management system 215 an indication of the interior door opening or images or other inputs to facilitate detecting when the interior door is opening or is open at 426. When the interior door opening is detected, security management system 215 can transmit, to the robot 102, a command to exit the elevator cab at 428. The exit elevator cab command may include one or more parameters for exiting the elevator cab, such as a speed of the robot 102 when exiting, etc.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more aspects, one or more of the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage de-vices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described herein that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A computer-implemented method for controlling a robot to use an elevator of a building, comprising:
receiving, from the robot, a tag indicating arrival at an elevator block;
transmitting, to an elevator system and based on receiving the tag, a credential for the robot;
receiving, from the elevator system, an indication of an elevator cab assigned to the robot; and
transmitting, to the robot, a command to travel to the elevator cab.

2. The computer-implemented method of claim 1, further comprising:
receiving, from the robot a second tag indicating arrival at the elevator cab; and
transmitting, to the robot, a command to at least one of detect door opening at an exterior of the elevator cab or enter the elevator cab when door opening at the exterior is detected.

3. The computer-implemented method of claim 2, further comprising receiving, from the robot one or more images for detecting the door opening, wherein the one or more images are collected by the robot using one or more of light detection and ranging (LiDAR), an infrared camera, or a red, green, blue (RGB) camera.

4. The computer-implemented method of claim 3, further comprising comparing the one or more images to images of elevator door openings using artificial intelligence to detect the door opening, wherein transmitting the command to enter the elevator cab is based on detecting the door opening.

5. The computer-implemented method of claim 2, wherein the command includes one or more of an indication of speed for the robot to move in entering the elevator cab, or an orientation of the robot to face within the elevator cab.

6. The computer-implemented method of claim 2, wherein the command further indicates to detect the door opening at an interior of the elevator cab and exiting the elevator cab when door opening at the interior is detected.

7. The computer-implemented method of claim 6, wherein the command includes an indication of speed for the robot to move in exiting the elevator cab.

8. The computer-implemented method of claim 1, further comprising:
transmitting, to the elevator system, an indication of a floor of the building to which the robot is to travel, wherein receiving the indication of the elevator cab is based on the indication of the floor; and
transmitting, to the robot, a map of the floor of the building.

9. The computer-implemented method of claim 1, further comprising transmitting, to the elevator system and based on receiving the tag, a personnel indicator for the robot indicating that the robot is to ride the elevator alone.

10. The computer-implemented method of claim 1, further comprising transmitting, to the robot, a command to erase information stored on the robot before entering the elevator cab.

11. An apparatus for controlling a robot to use an elevator of a building, comprising:
one or more memories configured to, individually or in combination, store instructions; and
one or more processors communicatively coupled with the one or more memories, wherein the one or more processors are, individually or in combination, configured to execute the instructions to cause the apparatus to:
receive, from the robot, a tag indicating arrival at an elevator block;
transmit, to an elevator system and based on receiving the tag, a credential for the robot;
receive, from the elevator system, an indication of an elevator cab assigned to the robot; and
transmit, to the robot, a command to travel to the elevator cab.

12. The apparatus of claim 11, wherein the one or more processors are, individually or in combination, configured to execute the instructions to cause the apparatus to:
receive, from the robot a second tag indicating arrival at the elevator cab; and
transmit, to the robot, a command to at least one of detect door opening at an exterior of the elevator cab or enter the elevator cab when door opening at the exterior is detected.

13. The apparatus of claim 12, wherein the one or more processors are, individually or in combination, configured to execute the instructions to cause the apparatus to receive, from the robot one or more images for detecting the door opening, wherein the one or more images are collected by the robot using one or more of light detection and ranging (LiDAR), an infrared camera, or a red, green, blue (RGB) camera.

14. The apparatus of claim 13, wherein the one or more processors are, individually or in combination, configured to execute the instructions to cause the apparatus to compare the one or more images to images of elevator door openings using artificial intelligence to detect the door opening, wherein the one or more processors are, individually or in combination, configured to execute the instructions to cause the apparatus to transmit the command to enter the elevator cab based on detecting the door opening.

15. The apparatus of claim 12, wherein the command includes one or more of an indication of speed for the robot to move in entering the elevator cab, or an orientation of the robot to face within the elevator cab.

16. The apparatus of claim 12, wherein the command further indicates to detect the door opening at an interior of the elevator cab and exiting the elevator cab when door opening at the interior is detected.

17. The apparatus of claim 12, wherein the one or more processors are, individually or in combination, configured to execute the instructions to cause the apparatus to:
transmit, to the elevator system, an indication of a floor of the building to which the robot is to travel, wherein the one or more processors are, individually or in combination, configured to execute the instructions to cause the apparatus to receive the indication of the elevator cab based on the indication of the floor; and
transmit, to the robot, a map of the floor of the building.

18. The apparatus of claim 11, wherein the one or more processors are, individually or in combination, configured to execute the instructions to cause the apparatus to transmit, to the elevator system and based on receiving the tag, a personnel indicator for the robot indicating that the robot is to ride the elevator alone.

19. One or more computer-readable media storing instructions, executable by one or more processors, for controlling a robot to use an elevator of a building, the instructions comprising instructions for:
receiving, from the robot, a tag indicating arrival at an elevator block;
transmitting, to an elevator system and based on receiving the tag, a credential for the robot;
receiving, from the elevator system, an indication of an elevator cab assigned to the robot; and
transmitting, to the robot, a command to travel to the elevator cab.

20. The one or more computer-readable media of claim 19, the instructions further comprising instructions for:
receiving, from the robot a second tag indicating arrival at the elevator cab; and
transmitting, to the robot, a command to at least one of detect door opening at an exterior of the elevator cab or enter the elevator cab when door opening at the exterior is detected.
